(19) United States
(12) Patent Application Publication
(10) Pub. No.: US 2004/0193925 A1
(43) Pub. Date: Sep. 30, 2004

(54) Portable password manager

(76) Inventor: Matnn Safriel, Tel-Aviv (IL)

Correspondence Address: KATTEN MUCHIN ZAVIS ROSENMAN, 575 MADISON AVENUE, NEW YORK, NY, 10022-2585, US

(21) Appl. No.: 10/811,278

(22) Filed: Mar. 26, 2004

Related U.S. Application Data
(60) Provisional application No. 60/457,329, filed on Mar. 26, 2003.

(51) Int. Cl. H04L 9/32

(52) U.S. Cl. 713/202

(57) ABSTRACT

The present invention is portable password manager device that can directly connect to a computer and fully perform without having to pre-configure or install a software application on the said computer or on the destination systems. The invention enables setting up portable devices, which may include USB or FireWire interfaces, flash memory, PDA's and cellular devices, to perform automatic signing-in to multiple information system destinations. A single device may manage multiple user configurations for more then one user, and multiple login credentials for the same destination system under a single user configuration. One user identifies to the device, all device activity is performed in a fully automatic manner turning the login process totally transparent for the user.

### FIELD OF INVENTION

The present invention relates to the field of identity validation procedures in multiple information systems and, more specifically, to an identity and password management solution.

### BACKGROUND OF THE INVENTION

Most information systems containing private information, individually sensitive information or personalized information require their users to identify themselves before granting access to the information. Similarly many information systems require their users to identify themselves before authorization and billing procedures. Often in such information systems each user is required to use login credentials such as a user ID, a password and possibly an additional identifier such as a PIN number or other identifiers. However, most information systems do not share login credentials and therefore a user that uses several information systems needs to be able to supply the correct login credentials to each information system that he or she wishes to use. This creates several practical problems since the user of multiple information systems needs to remember or record his or hers login credentials for each information system.

Several solutions for managing identification information are known in the art. Typically, these tools are software utilities, which are run on the user's personal computer, store the identity validation information of the different systems and enter it whenever the user accesses any of those systems. These tools are called password managers and some of them are even integrated into operating systems like Windows 2000 and Windows XP. Password managing utilities have two major shortcomings. First, since the information is stored locally, these systems only work on the computer on which they are installed. Whenever a user needs to access any of the information systems from a different computer these utilities obviously become ineffective. Second, having the identification information stored on the computer exposes it to possible intrusions and break-ins by hackers or other people with access to the computer.

To increase the portability and security some password managing systems make use of portable devices. For example, RoboForm, which is manufactured by Siber Systems Inc, is a password manager and one-click web form filler application which may utilize a USB flash drive for storing the confidential identification and password data. Storing the data on a portable device assures that the sensitive information is not available for unauthorized intrusions to the computer, whether physical ones or via a network communication. This device also allows the users to easily utilize the identification information on other computers. RoboForm's principle drawback is that in order to work, the software application must be installed on the computer. This might pose a major problem for users that may need to access their information systems from computers for which they do not have installation privileges, such as corporate computers, or from publicly used computers, such as in airport terminals, university campuses or in Internet Cafes, where installing a software utility is impossible, prohibited, inconvenient or time consuming.

Another solution is offered by MetaPass Inc. Their product is a dedicated plug and play USB flash drive password manager. The MetaPass device operates automatically once it is plugged in to the computer and does not require installing software beforehand. This invention has two major drawbacks. First, this solution may only be implemented on a preprogrammed USB flash drive and not on any other type of portable device. Second, using a dedicated USB flash device increases the cost of this product and limits its usability, since the device has to be purchased especially to this end. Users may not install it on generic devices which may already be in their possession and may not use this device for other purposes.

There is a need for a portable password manager which is truly practical to use, automatic and portable, that can be used with many computers without having to previously install on them, and that can utilize generic mobile devices. Such a solution will provide a real solution to the hassles and security problems of managing to authenticate to a variety of information systems, saving time and money.

### SUMMARY

A software application for login management residing on portable device is disclosed. This portable device, which can be connected to a computerized terminal, includes memory means, wherein said software application include: means for password managing, monitoring means for identifying login scenarios, interception means for identifying and recording new login data and means for providing login data to login challenges based on prerecorded data stored on said portable device memory. The portable device may be a USB flash memory device or a memory device that can easily connect to said computerized terminal through an SD interface.

The said portable device further includes communication means for directly connecting to said terminal via a USB connection. The software application, which also includes means for authenticating the user's identity to said software application, may be recorded on the portable device from a second memory means or downloaded to the portable device from an external network source.

The password managing means includes interface means enabling the user to manage the login information. The software application includes a configuration file enabling automatic activation of the software application or processed by the computerized terminal. The software application identified the login scenarios by detecting login challenge in existing and in new windows.

The interception process is initiated and preformed automatically not requiring user interaction, and without requiring any prior installation and no configuration changes on said computerized terminal are required.

The software application supports using more than one user identity for the same destination system, and enables the user to select the login identity from said software for a login challenge from an automatically displayed user interface element. On the other hand, the process of providing the login data may also be initiated and preformed automatically without requiring user interaction, performed by a single click, or by

positioning the mouse pointer and performing a single mouse double-click operation. The software application of claim 1 wherein said

### BRIEF DESCRIPTION OF THE DRAWINGS

These and further features and advantages of the invention will become more clearly understood in light of the ensuing description of a preferred embodiment thereof, given by way of example only, with reference to the accompanying drawings, wherein—

FIG. 1 is a block diagram of the environment's data components according to the preferred embodiment of the present invention;

FIG. 2 is a flowchart of the portable device's configuration procedure according to the preferred embodiment of the present invention;

FIG. 3 is a flowchart of the operational procedure of the preferred embodiment of the present invention.

### DETAILED DESCRIPTION OF THE PREFERRED EMBODIMENT

The present invention is a software application which enables the user to create an active portable password manager on a portable device that can directly connect to a computer. The invention enables setting up portable devices, which may include USB or FireWire interfaces, PDA's and cellular devices, to perform automatic signing-in to multiple information system destinations, without having to pre-configure or install a software application on the said computer or on the destination systems. This provides a breakthrough user experience of reliably persisting personal authentication credentials, while protecting and securing online identities in a portable manner.

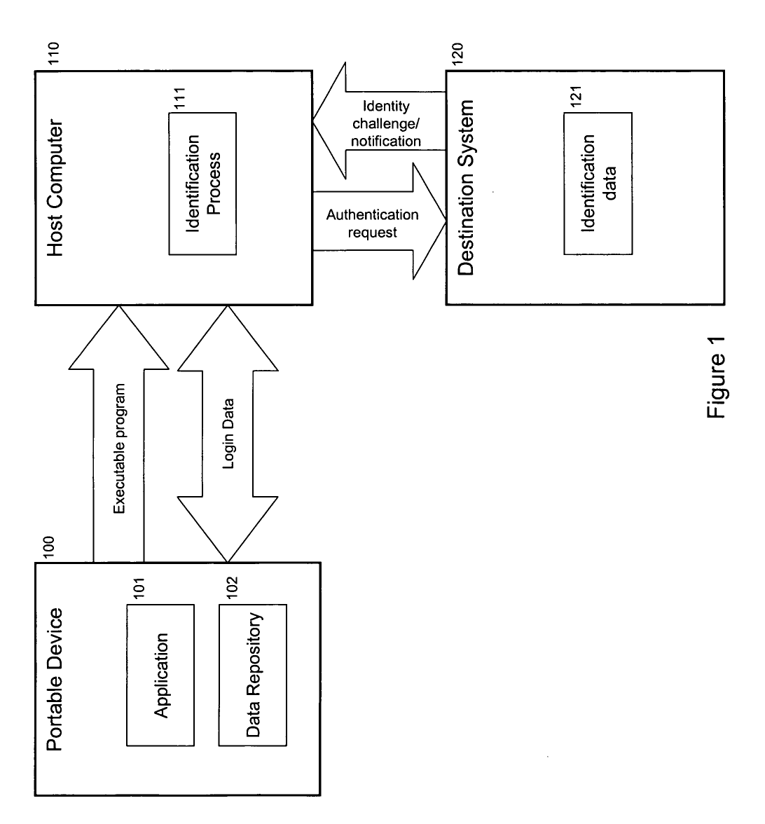

The operational environment of the portable device may be better understood in view of FIG. 1. As illustrated in FIG. 1, the operational environment is comprised of the portable device 100 holding the login information 102 and software application component 101 which manage the operation of the device, a host computer 110 on which the identification process 111 occurs and a remote system 120 requiring the identification procedure. As the remote system 120 sends the identification request to the host computer 110, the portable device 100 reads the request, and sends the required information to the host computer 110. The identification data is then sent to the remote system.

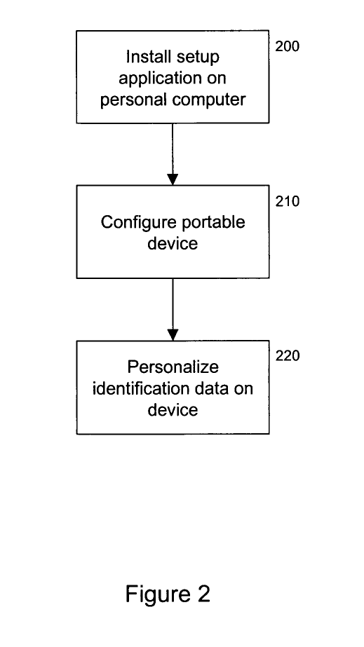

The preferred embodiment of the present invention is comprised of a device configuring software application that is designed to set-up portable devices and at least one portable device that can maintain two-way communication with the computer. The software application sets up the portable device to function as a password manager as it connects to any computer. FIG. 2 is a simplified flowchart of the configuration procedure of the portable device according to the preferred embodiment of the present invention. The configuring software application is installed on a computer 200. Then the portable device may be connected to that computer and configured by the application 210. This configuration may include, for instance, determining the authentication validation method for activating the device. The configuration preferences of the portable device may then be personalized 220 to fit the needs of the user. The same portable device may be configured to different personal profiles so it may be used by more then one user, and the same user definitions may be used to configure more then one portable device if needed. Alternatively, the software may be preprogrammed into the device's memory, without needing to make use of an installation program.

Once the portable device is configured the user may connect the device to any host computer running an operating system supported by the software, and use the software on the host computer without having to configure the host computer or install software components on it. In a preferred embodiment the software is activated automatically provided that the host computer operating system and the portable device can enable automatic activation of software from the portable device. The automatic activation of the software in this preferred embodiment is accomplished through the auto-run features of the host computer operating system or of a third party software such as M-Systems' Mykey™ software. In both cases, a configuration file on the portable device configures the auto-run of the software. Then, the user need only connect the device to the host computer, thus automatically initiating the software, which as described below, can in turn automatically authenticate the user's identity. Simply connecting the portable device to the host computer enables the “no-click authentication” effect.

An identification process through a PIN code or password, for example, can be used to protect the system from unauthorized use if the device is lost, stolen or left unattended. The system may also employ a device which incorporates biometric identification means and may use these means to validate the identity of the user before activating the system.

The system may also utilize other security measures to protect the information on the mobile device such as encryption, hardware encryption, limiting the accessibility to sensitive storage areas, write protection mechanisms of the software executable and run-time resources, means for detecting security anomalies or tampering on the host computer and so on.

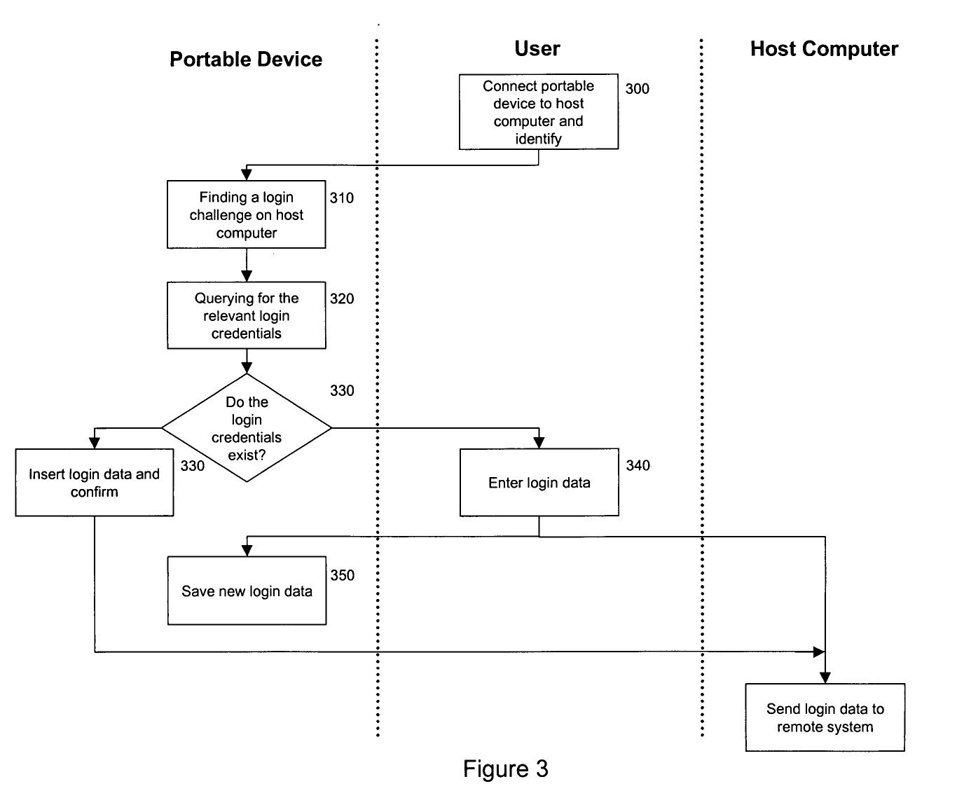

A flowchart illustrating the operational procedure is in FIG. 3. Once the device is connected to the computer and identifies 300, the program continuously examines all running windows 310. For each window the program determines whether it contains a login challenge. If a window contains a login challenge the program searches the system data repository residing on the mobile device for relevant login credentials for the information system that the login challenge is for 320. In case one matching set of login credentials is found in the system data repository, the program inserts the login credentials retrieved from the system data repository into the window containing the login challenge, and then simulates the acceptance action of the user submitting the login credentials in the window 330.

If there are no matching login credentials in the system data repository then the program retrieves the values entered by the user 340 as login credentials once the user submits them in the window. The user need not insert the login information manually to the system. The program stores these retrieved values in the system data repository and also stores the information regarding the relevant information system requiring the login 350.

In case more than one set of login credentials is found in the system data repository to be relevant to the current information system the program lets the user choose which identity to login with by displaying a list of the login credential sets relevant for the information system. The program then receives the user's selection from the list and inserts the chosen login credential set into the window containing the login challenge, and then simulates the acceptance action of the user submitting the login credentials in the window.

The system may also allow the user to indicate that he or she wishes to add new login credentials to an information system for which there are already valid login credentials in the data repository. In this case the program enables the user to enter login credentials and then it stores them in the system data repository so that they are thereafter available for the user. The system may also provide services to more than one user through a single device. In such cases the system may separately manage data for several users. In order to distinguish between users in such embodiment, and to protect the privacy and data security of each user, the system may make use of standard methods for achieving these goals such as operating different user logins on the device, for example. In addition, a preferred embodiment may also include a user interface enabling the user to manage the login information recorded by the program such as to view recorded login credentials, backup login credentials, provide meaningful names for login credential sets, remove or change recorded information and other administrative tasks.

Although the description above relates to an embodiment that is based on a USB flash drive, the present invention may also be implemented on any other small portable devices that may easily connect to a computer. Such devices may include flash cards, PDA devices, cellular devices and the like and may operate, for instance, via wireless Bluetooth connection technology.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A software application for login management residing on portable device which can be connected to a computerized terminal, said portable device include memory means, wherein said software application include: means for password managing, monitoring means for identifying login scenarios, interception means for identifying and recording new login data and means for providing login data to login challenges based on prerecorded data stored on said portable device memory.

2. The software application of claim 1 wherein the portable device further includes communication means for directly connecting to said terminal.

3. The software application of claim 2 wherein said communication means is USB connection.

4. The software application of claim 1 further including means for authenticating the user's identity to said software application.

5. The software application of claim 1 wherein said application is recorded on the portable device from a second memory means.

6. The software application of claim 1 wherein said application is downloaded to the portable device from an external network source.

7. The software application of claim 1 wherein the password managing means includes interface means enabling the user to manage the login information.

8. The software application of claim 1 further including a configuration file enabling automatic activation of said software application.

9. The software application of claim 1 wherein the login scenarios are identified by detecting existing and new running windows and identifying login challenge thereof.

10. The software application of claim 1 wherein the software application is processed by the computerized terminal.

11. The software application of claim 1 wherein the interception process is initiated and preformed automatically without requiring user interaction.

12. The software application of claim 1 wherein for the operation of said software application no prior installation and no configuration changes on said computerized terminal are required.

13. The software application of claim 1 wherein the software application supports using more than one user identity for the same destination system.

14. The software application of claim 1 wherein the process of providing the login data is initiated and preformed automatically without requiring user interaction.

15. The software application of claim 1 wherein the user is enabled to select the login identity from said software for a login challenge from an automatically displayed user interface element.

16. The software application of claim 15 wherein said selection is performed by a single click.

17. The software application of claim 15 wherein said selection is performed positioning the mouse pointer and performing a single mouse double-click operation.

18. The software application of claim 1 wherein said portable device is a USB flash memory device.

19. The software application of claim 1 wherein the portable device is a memory device that can easily connect to said computerized terminal through an SD interface.
